(19) United States
(12) Patent Application Publication
(10) Pub. No.: US 2022/0020008 A1
(43) Pub. Date: Jan. 20, 2022

(54) Smart Contract-Based Electronic Contract Preservation System

(71) Applicant: Jiangsu Aowei Holdings Co., Ltd., Nanjing (CN)

(72) Inventor: Jie BAI, Nanjing (CN)

(73) Assignee: Jiangsu Aowei Holdings Co., Ltd., Nanjing (CN)

(21) Appl. No.: 17/379,800

(22) Filed: Jul. 19, 2021

(30) Foreign Application Priority Data
Jul. 20, 2020 (CN) 202010699054.7
Sep. 9, 2020 (CN) 202010938091.9

(51) Int. Cl. G06Q 20/38; G06F 16/22

(52) U.S. Cl. CPC G06Q 20/389; G06F 16/2246; G06Q 2220/10; G06Q 20/3827; G06Q 20/3825; G06Q 20/3829

(57) ABSTRACT

The present application discloses a smart contract-based electronic contract deposit system, including an electronic contract platform, a blockchain deposit platform, and a transaction processing smart contract created by the electronic contract platform or the blockchain deposit platform, where the blockchain deposit platform includes a plurality of deposit nodes that provide deposit services for the electronic contract platform. In this way, the following problem may be resolved: regarding an existing manner of storing an electronic contract in a centralized way, during a subsequent process of invoking electronic contract data, the stored electronic contract data becomes untrustworthy because the contract data is at a risk of being easily tampered with and forged.

The present application claims the priority to the Chinese Application No. 202010699054.7, filed with the Chinese Patent Office on Jul. 20, 2020 and entitled “SMART CONTRACT-BASED ELECTRONIC CONTRACT DEPOSIT SYSTEM”, which is incorporated herein by reference in its entirety.

### FIELD OF THE INVENTION

The present application relates to the field of electronic contract deposit technologies, and in particular, to a smart contract-based electronic contract deposit system.

### BACKGROUND OF THE INVENTION

With development of the Internet era, at present, an electronic contract platform signs and seals an electronic contract through a certificate of a user issued by a certificate authority (CA), having same legal effects. In this way, the electronic contract, as a form of contract, is gradually widely used.

However, for the moment, usually a database storage platform is used to store the electronic contract. Such storage manner is essentially centralized storage, and contract data is at a risk of being easily tampered with and forged. Therefore, during a subsequent process of invoking the electronic contract data, the stored electronic contract data becomes untrustworthy. As a result, the storage of the electronic contract data becomes meaningless.

### SUMMARY OF THE INVENTION

The present application provides a smart contract-based electronic contract deposit system, and may resolve the following problem: regarding an existing manner of storing an electronic contract in a centralized way, during a subsequent process of invoking electronic contract data, the stored electronic contract data becomes untrustworthy because the contract data is at a risk of being easily tampered with and forged.

A smart contract-based electronic contract deposit system, including an electronic contract platform, a blockchain deposit platform including a plurality of deposit nodes that provide deposit services for the electronic contract platform, and a transaction processing smart contract created by the electronic contract platform or the blockchain deposit platform, where

the electronic contract platform is configured with:

a deposit information generation step: preprocessing an electronic contract, to obtain deposit information;

a data processing step: encrypting and discretizing the deposit information, to generate a corresponding data tree;

a transaction construction step: constructing a contract transaction, where an initiator of the contract transaction is a user, a receiver is an address of a corresponding transaction processing smart contract, and the contract transaction is signed by both of a private key of the user and a private key of the electronic contract platform; and

a data sending step: sending the deposit information, the data tree, and the contract transaction to the blockchain deposit platform; and

each of the deposit nodes is configured with:

a verification step: verifying legitimacy, integrity, and validity of the received deposit information, data tree, and contract transaction by using a public key of the user and a public key of the electronic contract platform;

a smart contract invoking step: invoking the transaction processing smart contract, transmitting the deposit information, the data tree, and the contract transaction to the transaction processing smart contract, and executing the transaction processing smart contract to obtain a smart-contract execution result;

a data block generation step: generating a data block from the smart-contract execution result;

a step of uploading and storing on a chain: uploading and storing the deposit information, the data tree, the contract transaction, the smart-contract execution result, and the data block on a chain;

a transaction hash operation step: performing a hash operation on the contract transaction, to obtain a transaction hash value;

a data transmitting back step: transmitting the deposit information, the data tree, the contract transaction, the smart-contract execution result, the data block, and the transaction hash value back to the electronic contract platform; and

a data transmitting forward step: transmitting the deposit information, the data tree, the contract transaction, the smart-contract execution result, the data block, and the transaction hash value to a next deposit node.

It may be learned from the foregoing technical solution that the smart contract-based electronic contract deposit system provided in the present application includes the electronic contract platform, the blockchain deposit platform, and the transaction processing smart contract created by the electronic contract platform or the blockchain deposit platform, where the blockchain deposit platform includes a plurality of deposit nodes that provide deposit services for the electronic contract platform. According to the smart contract-based electronic contract deposit system in the present application, the electronic contract is deposited through the electronic contract platform in combination with the blockchain technology. The credibility of electronic contract deposit is ensured by using characteristics of a blockchain, such as decentralization, cannot be tampered with, leaving tracks throughout the process, being traceable, being collectively maintained, and being open and transparent. By constructing a transaction processing smart contract, the electronic contract is uploaded to the blockchain deposit platform for deposit. First, electronic contract data sent to the blockchain deposit platform is encrypted and discretized, and the data tree is generated, thereby being more conducive to anti-tampering of the data, and enhancing security and privacy during a data transmission process. By means of signing by using the private key and verifying by using the public key, feasibility of a deposit process of the electronic contract is further enhanced, to prevent the electronic contract from being tampered with and forged. When a contract dispute occurs, technically, it may be guaranteed that no party involved in the electronic contract can tamper with the contract.

### BRIEF DESCRIPTION OF THE DRAWINGS

To more clearly describe the technical solutions of the present application, the accompanying drawings to be used in the embodiments are briefly illustrated below. Obviously, persons of ordinary skills in the art can also derive other accompanying drawings according to these accompanying drawings without an effective effort.

FIG. 1 is a topology view of a first smart contract-based electronic contract deposit system according to an embodiment of the present application;

FIG. 2 is a data processing flowchart of the smart contract-based electronic contract deposit system shown in FIG. 1;

FIG. 3 is a flowchart of method steps corresponding to the data processing flowchart shown in FIG. 2;

FIG. 4 is a flowchart of data splitting corresponding to a second smart contract-based electronic contract deposit system according to an embodiment of the present application; and

FIG. 5 is a flowchart of data splitting corresponding to a third smart contract-based electronic contract deposit system according to an embodiment of the present application.

### DETAILED DESCRIPTION OF THE EMBODIMENTS

The technical solutions in the embodiments of the present application are clearly and completely described below in combination with the accompanying drawings in the embodiments of the present application. Obviously, the described embodiments are merely some and not all of embodiments of the present application. According to the embodiments of the present application, all other embodiments derived by persons of ordinary skills in the art without an effective effort fall within the protection scope of the present application.

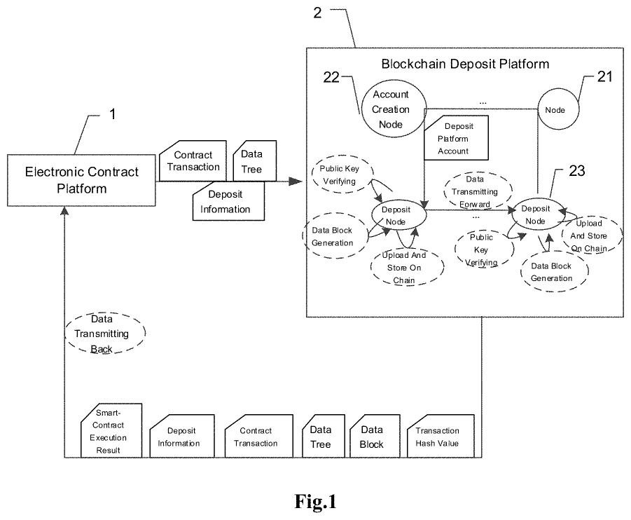

FIG. 1 is a topology view of a first smart contract-based electronic contract deposit system according to an embodiment of the present application. As shown in FIG. 1, the smart contract-based electronic contract deposit system provided in this embodiment includes an electronic contract platform 1, a blockchain deposit platform 2, and a transaction processing smart contract. The transaction processing smart contract may be created by the electronic contract platform 1 or may be created by the blockchain deposit platform 2. The blockchain deposit platform 2 may include a plurality of nodes 21 that are capable of peer-to-peer communication. At least one node 21 may serve as an account creation node 22, to provide account creation services for the electronic contract platform 1. A plurality of nodes 21 may serve as deposit nodes 23, to provide deposit services for the electronic contract platform 1. Deposit data of the electronic contract may include basic information as shown in Table 1, which is a comparison table of the basic information of the deposit data of the electronic contract.

TABLE 1

| Item | Field content | Postscript content |
|---|---|---|
| User Registration | User ID | User ID, user IP |
| Information | | |
| Personal Identity | Name, ID Number, | User ID, user IP, And ID Number |
| Information | Mobile Phone | |
| | Number, And Bank | |
| | Card Number | |
| Enterprise Real- | Company Name, | User ID, User IP, Enterprise |
| Name Information | Enterprise | Organization Code |
| | Organization Code | |
| Digital Certificate | CA Certificate File | User ID, User IP, CA Certificate |
| Issuing | | File Name, CA Organization |
| Information | | |
| Deposit | Mobile Phone | User ID, User IP, Contract |
| Information | Number, SMS Text | Number, Signatories (Party A, |
| About Signing | | Party B) |
| Willingness | | |
| Contract Signing | Contractual | Contract Number, Contract |
| Information | Document | Name, User ID Of Party A, User |
| | | ID Of Party B |
| System Log | Log File | File Name, Log Creation Date |
| Information | | (In YYYY-MM-DD Format) |

It should be noted that the electronic contract platform 1 and the blockchain deposit platform 2 described in the present application respectively may be one of a public chain, a subchain, or a federated chain that are communicatively connected to a certain blockchain or a plurality of blockchains. The electronic contract platform 1 may be a functional subchain or a federated chain; the blockchain deposit platform 2 may be a public chain, a functional subchain, or a federated chain; and the electronic contract platform 1 may also be an existing Internet of Things platform. This is not specifically limited in the present application.

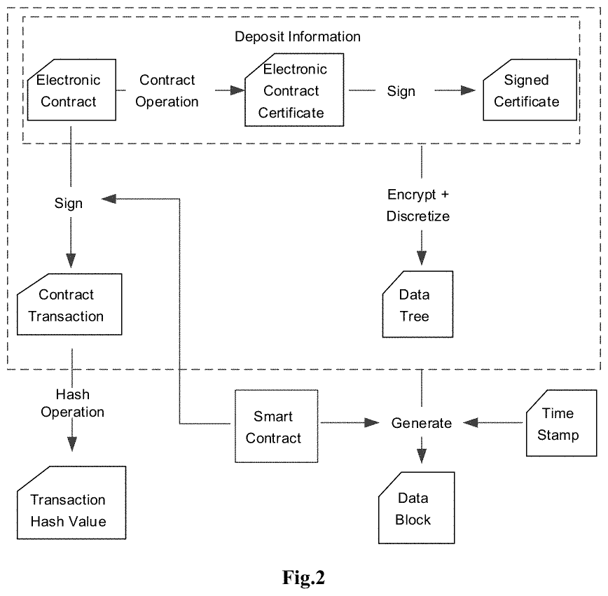

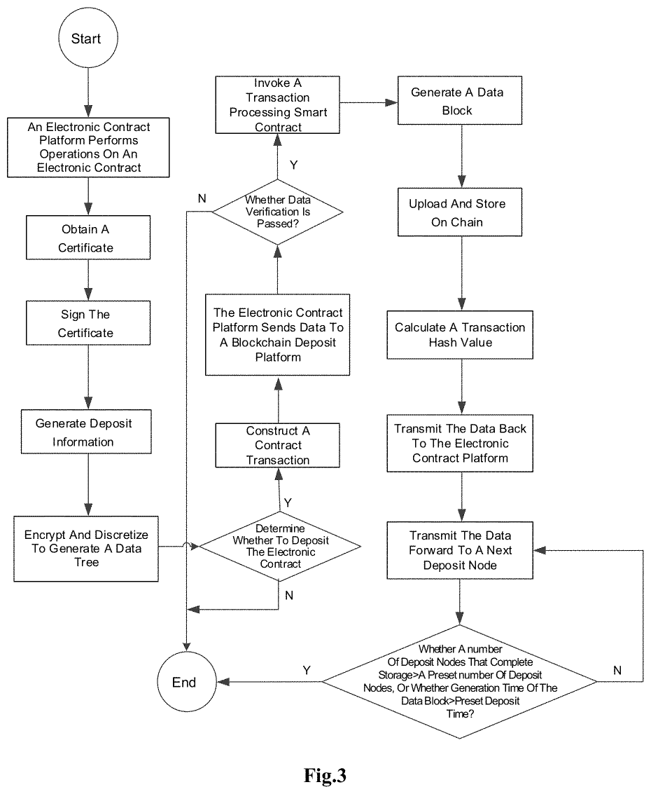

FIG. 2 is a data processing flowchart of the smart contract-based electronic contract deposit system shown in FIG. 1. FIG. 3 is a flowchart of method steps corresponding to the data processing flowchart shown in FIG. 2. With reference to FIG. 1 to FIG. 3, the electronic contract platform 1 may be configured with:

a deposit information generation step: preprocessing an electronic contract, to obtain deposit information.

The deposit information generation step may further include the following steps:

a contract operation step: performing related operations on the electronic contract, to obtain a contract operation result, where the related operations include signing, renewal, modification, and termination;

a certificate obtaining step: obtaining an electronic contract certificate corresponding to the contract operation result, where the electronic certificate may be a legal electronic certificate issued by the electronic contract platform or a third-party CA platform; and

a certificate signature scheme selection step: selecting a signature scheme of the electronic contract certificate, and signing the electronic contract certificate, to obtain a signed certificate, the signature scheme including a local signature, an electronic contract platform signature, and a deposit platform signature, where the deposit information may include the contract operation result, the electronic contract certificate, and the signed certificate.

If the local signature is selected when the electronic contract platform 1 completes the certificate signature scheme selection step, the electronic contract certificate is signed by using a private key of a user, to obtain the signed certificate.

If the electronic contract platform signature is selected when the electronic contract platform 1 completes the certificate signature scheme selection step, the electronic contract certificate is signed by using a private key of the electronic contract platform, to obtain the signed certificate.

If the deposit platform signature is selected when the electronic contract platform 1 completes the certificate signature scheme selection step, the electronic contract certificate is signed by using a public key of the blockchain deposit platform, to obtain the signed certificate.

The private key and the public key appear correspondingly. After the electronic contract is signed by using the private key, it may be convenient to restore the signed certificate in the following by using the public key, so as to invoke the electronic contract.

After the deposit information is generated, proceeding to a data processing step to be performed, to encrypt and discretize the deposit information so as to generate a corresponding data tree.

Subsequently, the electronic contract platform 1 is further configured with an uploading determining step, to determine whether or not to deposit the electronic contract in the blockchain deposit platform. When it is determined not to deposit the electronic contract in the blockchain deposit platform, a deposit process of the electronic contract ends.

When it is determined to deposit the electronic contract in the blockchain deposit platform, proceeding to a transaction construction step to be performed, to construct a contract transaction. An initiator of the contract transaction is the user, and a receiver is an address of a corresponding transaction processing smart contract. The contract transaction is signed by both of the private key of the user and the private key of the electronic contract platform. The contract transaction may be used to record the deposit process of the electronic contract.

Finally, a data sending step is performed, to send the deposit information, the data tree, and the contract transaction to the blockchain deposit platform.

The account creation node 22 may be configured with an account creation step, to create a deposit platform account for the electronic contract platform. After the account creation step is completed, the deposit node 23 continues to perform a deposit-related step.

The deposit node 23 may be configured with:

a verification step: verifying legitimacy, integrity, and validity of the received deposit information, data tree, and contract transaction by using a public key of the user and a public key of the electronic contract platform;

When the verification step is passed, proceeding to a smart contract invoking step to be performed, to invoke the transaction processing smart contract, transmit the deposit information, the data tree, and the contract transaction to the transaction processing smart contract, and execute the transaction processing smart contract to obtain a smart-contract execution result.

When the verification step is not passed, the deposit process of the electronic contract ends.

a data block generation step: generating a data block from the smart-contract execution result;

a step of uploading and storing on a chain: uploading and storing the deposit information, the data tree, the contract transaction, the smart-contract execution result, and the data block on a chain;

a transaction hash operation step: performing a hash operation on the contract transaction, to obtain a transaction hash value;

a data transmitting back step: transmitting the deposit information, the data tree, the contract transaction, the smart-contract execution result, the data block, and the transaction hash value back to the electronic contract platform; and

a data transmitting forward step: transmitting the deposit information, the data tree, the contract transaction, the smart-contract execution result, the data block, and the transaction hash value to a next deposit node.

According to another smart contract-based electronic contract deposit system provided in this embodiment, a preset number of deposit nodes is set in the transaction processing smart contract; and the deposit node 23 is further configured with:

a deposit node number determining step: determining whether a number of the deposit nodes that complete the step of uploading and storing on a chain exceeds the preset number of deposit nodes; and

a deposit process completion step: when the number of the deposit nodes that complete the step of uploading and storing on a chain exceeds the preset number of deposit nodes, completing execution of the transaction processing smart contract, ending a deposit process of the electronic contract, and stopping proceeding to the data transmitting forward step.

When the number of the deposit nodes that complete the step of uploading and storing on a chain does not exceed the preset number of deposit nodes, proceeding to the data transmitting forward step to be performed.

According to still another smart contract-based electronic contract deposit system provided in this embodiment, a preset deposit time is set in the transaction processing smart contract; and the deposit node 23 is further configured with:

a deposit time determining step: determining whether generation time of the data block exceeds the preset deposit time; and

a deposit process completion step: when the generation time of the data block exceeds the preset deposit time, completing execution of the transaction processing smart contract, ending a deposit process of the electronic contract, and stopping proceeding to the data transmitting forward step. When the generation time of the data block exceeds the preset deposit time, it represents that there are sufficient blocks after a serial number of the data block on the blockchain deposit platform 2. In other words, there are sufficient data blocks on the blockchain deposit platform 2 to deposit relevant data of the electronic contract. At this time, the execution of the transaction processing smart contract has been completed. The deposit node number determining step and the deposit time determining step are mutually replaceable, and one of the two steps may be selected for execution. This is not specifically limited in the present application.

When the generation time of the data block does not exceed the preset deposit time, proceeding to the data transmitting forward step to be performed.

It should be noted that both the foregoing preset number of deposit nodes and the preset deposit time may be set in advance according to actual requirements. It is required that there are sufficient deposit nodes on the blockchain deposit platform to deposit the electronic contract, so as to ensure validity and reliability of deposit. Each deposit node needs to regenerate a new data block. Each data block has a corresponding time stamp, to mark a time attribute of the data block. By setting the preset number of deposit nodes and the preset deposit time in the transaction processing smart contract, validity and reliability of storing the electronic contract on the blockchain deposit platform may be ensured, being more efficient.

In addition, regarding uploading and storing on a chain of the blockchain deposit platform 2, it is not specifically limited in the present application on whether a storage mode is storing original data synchronously, or storing merely a data digest of the original data or compressed data.

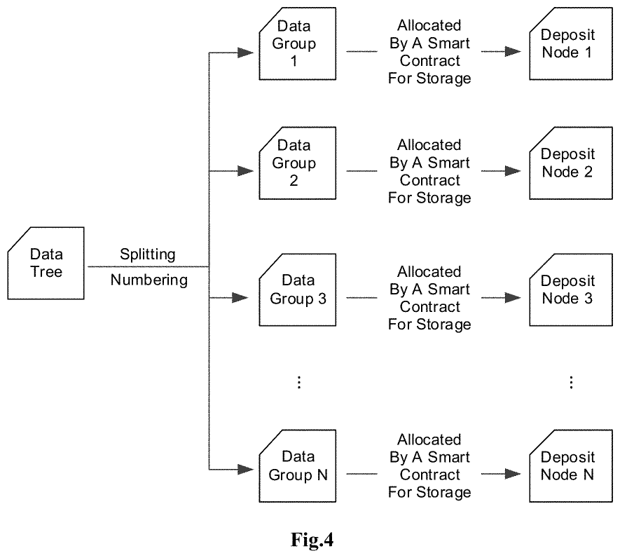

FIG. 4 is a flowchart of data splitting corresponding to a second smart contract-based electronic contract deposit system according to an embodiment of the present application. As shown in FIG. 4, according to the smart contract-based electronic contract deposit system provided in this embodiment, at least one of the nodes 21 of a blockchain deposit platform 2 may further serve as a data splitting node.

The data splitting node is configured with a data splitting step, to split a received data tree, to obtain a plurality of data groups. The data tree may be split into n number of data groups, and then it proceeds to a numbering step to be performed, to number each of the data groups, where the data groups may be numbered as data group 1, data group 2, data group 3, data group 4, . . . , and data group n, and n is any positive integer. In this case, a transaction processing smart contract allocates a corresponding deposit node to each of the data groups for storage. The deposit node is further configured with a group storage step, to store the data group allocated by the transaction processing smart contract. Proceeding to the data transmitting forward step to be performed after the storage is completed. For example, the data group 1, the data group 2, the data group 3, the data group 4, . . . , and the data group n may be stored in a deposit node 1, a deposit node 2, a deposit node 3, a deposit node 4, . . . , and a deposit node n, respectively.

In this embodiment, the data tree is obtained by encrypting and discretizing deposit information. The blockchain deposit platform 2 may split the data tree into a plurality of data groups, so that the data tree is stored dispersedly on a plurality of nodes of the blockchain deposit platform security of storage of the data tree on the blockchain deposit platform being further enhanced. When data of the data tree needs to be restored for evidence, the data group may be reconstituted and decrypted.

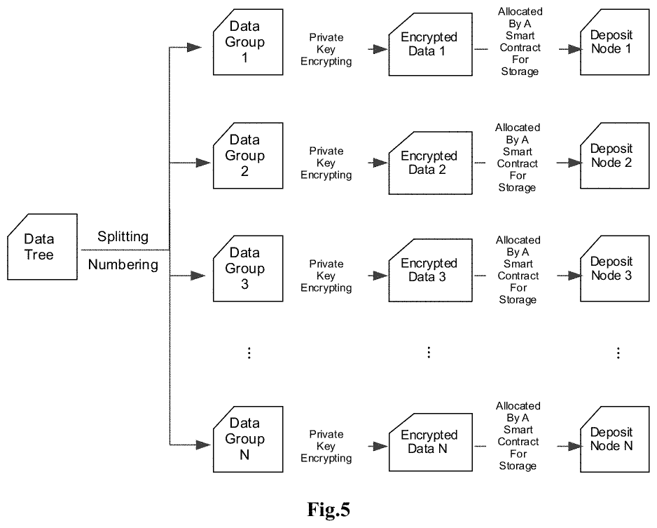

FIG. 5 is a flowchart of data splitting corresponding to a third smart contract-based electronic contract deposit system according to an embodiment of the present application. As shown in FIG. 5, according to the smart contract-based electronic contract deposit system provided in this embodiment, an electronic contract platform 1 may be further configured with a data splitting step, to split a data tree to obtain a plurality of data groups. The data tree may be split into n number of data groups, and then it may proceed to a numbering and encrypting step to be performed, to number each of the data groups, where the data groups may be numbered as data group 1, data group 2, data group 3, data group 4, . . . , and data group n. By encrypting each of the data groups by using a private key of a user or a private key of the electronic contract platform, encrypted data 1, encrypted data 2, encrypted data 3, encrypted data 4, . . . , and encrypted data n may be obtained. Proceeding to a data sending step to be performed after the encryption is completed. In this case, a transaction processing smart contract allocates a corresponding deposit node to each of the data groups for storage. The deposit node is further configured with a group storage step, to store the data group allocated by the transaction processing smart contract. Proceeding to the data transmitting forward step to be performed after the storage is completed. For example, the encrypted data 1, the encrypted data 2, the encrypted data 3, the encrypted data 4, . . . , and the encrypted data n may be stored in a deposit node 1, a deposit node 2, a deposit node 3, a deposit node 4, . . . , and a deposit node n, respectively.

In this embodiment, the data tree is obtained by encrypting and discretizing deposit information. The electronic contract platform may split the data tree into a plurality of data groups. Due to occurrence of data transmission, the data groups needs to be encrypted, so that the data tree is stored dispersedly on a plurality of nodes of the blockchain deposit platform, security of storing the data tree on the blockchain deposit platform being further enhanced.

According to the smart contract-based electronic contract deposit system provided in the present application, the electronic contract is deposited through the electronic contract platform in combination with the blockchain technology. The credibility of the electronic contract deposit is ensured by using characteristics of a blockchain, such as decentralization, cannot be tampered with, leaving tracks throughout the process, being traceable, being collectively maintained, and being open and transparent. The contract transaction is constructed by using the transaction processing smart contract, and the electronic contract is uploaded to the blockchain deposit platform for deposit. First, electronic contract data sent to the blockchain deposit platform is encrypted and discretized, and the data tree is generated, thereby being more conducive to anti-tampering of the data, and enhancing security and privacy during a data transmission process. By means of signing by using the private key and verifying by using the public key, feasibility of the deposit process of the electronic contract is further enhanced, to prevent the electronic contract from being tampered with and forged. When a contract dispute occurs, technically, it may be guaranteed that no party involved in the electronic contract can tamper with the contract.

For same or similar parts between the embodiments in this specification, reference may be made to each other.

What is claimed is:

1. A smart contract-based electronic contract deposit system, comprising an electronic contract platform, a blockchain deposit platform comprising a plurality of deposit nodes that provide deposit services for the electronic contract platform, and a transaction processing smart contract created by the electronic contract platform or the blockchain deposit platform, wherein
the electronic contract platform is configured with:
a deposit information generation step: preprocessing an electronic contract, to obtain deposit information;
a data processing step: encrypting and discretizing the deposit information, to generate a corresponding data tree;
a transaction construction step: constructing a contract transaction, wherein an initiator of the contract transaction is a user, a receiver is an address of a corresponding transaction processing smart contract, and the contract transaction is signed by both of a private key of the user and a private key of the electronic contract platform; and
a data sending step: sending the deposit information, the data tree, and the contract transaction to the blockchain deposit platform; and
each of the deposit nodes is configured with:
a verification step: verifying legitimacy, integrity, and validity of the received deposit information, data tree, and contract transaction by using a public key of the user and a public key of the electronic contract platform;
a smart contract invoking step: invoking the transaction processing smart contract, transmitting the deposit information, the data tree, and the contract transaction to the transaction processing smart contract, and executing the transaction processing smart contract to obtain a smart-contract execution result;
a data block generation step: generating a data block from the smart-contract execution result;
a step of uploading and storing on a chain: uploading and storing the deposit information, the data tree, the contract transaction, the smart-contract execution result, and the data block on a chain;
a transaction hash operation step: performing a hash operation on the contract transaction, to obtain a transaction hash value;
a data transmitting back step: transmitting the deposit information, the data tree, the contract transaction, the smart-contract execution result, the data block, and the transaction hash value back to the electronic contract platform; and
a data transmitting forward step: transmitting the deposit information, the data tree, the contract transaction, the smart-contract execution result, the data block, and the transaction hash value to a next deposit node.

2. The smart contract-based electronic contract deposit system according to claim 1, wherein a preset number of deposit nodes is set in the transaction processing smart contract; and
each of the deposit nodes is further configured with:
a deposit node number determining step: determining whether a number of the deposit nodes that complete the step of uploading and storing on a chain exceeds the preset number of deposit nodes; and
a deposit process completion step: when the number of the deposit nodes that complete the step of uploading and storing on a chain exceeds the preset number of deposit nodes, completing execution of the transaction processing smart contract, ending a deposit process of the electronic contract, and stopping proceeding to the data transmitting forward step.

3. The smart contract-based electronic contract deposit system according to claim 1, wherein preset deposit time is set in the transaction processing smart contract; and
each of the deposit nodes is further configured with:
a deposit time determining step: determining whether generation time of the data block exceeds the preset deposit time; and
a deposit process completion step: when the generation time of the data block exceeds the preset deposit time, completing execution of the transaction processing smart contract, ending a deposit process of the electronic contract, and stopping proceeding to the data transmitting forward step.

4. The smart contract-based electronic contract deposit system according to claim 1, wherein the blockchain deposit platform further comprises at least one data splitting node; and
the data splitting node is configured with:
a data splitting step: splitting the received data tree, to obtain a plurality of data groups; and
a numbering step: numbering each of the data groups;
the transaction processing smart contract allocates a corresponding deposit node to each of the data groups for storage; the deposit node is further configured with a group storage step, to store the data group allocated by the transaction processing smart contract; and proceeding to the data transmitting forward step to be performed after the storage is completed.

5. The smart contract-based electronic contract deposit system according to claim 1, wherein the electronic contract platform is further configured with:
a data splitting step: splitting the data tree, to obtain a plurality of data groups; and
a numbering and encrypting step: numbering each of the data groups, and encrypting each of the data groups by using the private key of the user, proceeding to the data transmitting forward step to be performed after the encryption is completed;
the transaction processing smart contract allocates a corresponding deposit node to each of the data groups for storage; the deposit node is further configured with a group storage step, to store the data group allocated by the transaction processing smart contract; and proceeding to the data transmitting forward step to be performed after the storage is completed.

6. The smart contract-based electronic contract deposit system according to claim 1, wherein the electronic contract platform is further configured with:
a data splitting step: splitting the data tree, to obtain a plurality of data groups; and
a numbering and encrypting step: numbering each of the data groups, and encrypting each of the data groups by using the private key of the electronic contract platform, proceeding to the data transmitting forward step to be performed after the encryption is completed;
the transaction processing smart contract allocates a corresponding deposit node to each of the data groups for storage; the deposit node is further configured with a group storage step, to store the data group allocated by the transaction processing smart contract; and proceeding to the data transmitting forward step to be performed after the storage is completed.

7. The smart contract-based electronic contract deposit system according to claim 1, wherein the deposit information generation step specifically comprises:
a contract operation step: performing related operations on the electronic contract, to obtain a contract operation result, wherein the related operations comprise signing, renewal, modification, and termination;
a certificate obtaining step: obtaining an electronic contract certificate corresponding to the contract operation result; and
a certificate signature scheme selection step: selecting a signature scheme of the electronic contract certificate, and signing the electronic contract certificate, to obtain a signed certificate, wherein the signature scheme comprises a local signature, an electronic contract platform signature, and a deposit platform signature; and
the deposit information comprises the contract operation result, the electronic contract certificate, and the signed certificate.

8. The smart contract-based electronic contract deposit system according to claim 7, wherein if the local signature is selected when the electronic contract platform completes the certificate signature scheme selection step, the electronic contract certificate is signed by using the private key of the user, to obtain the signed certificate; and the electronic contract platform is further configured with:
an uploading determining step: determining whether or not to deposit the electronic contract in the blockchain deposit platform; and when it is determined to deposit the electronic contract in the blockchain deposit platform, proceeding to the transaction construction step to be performed.

9. The smart contract-based electronic contract deposit system according to claim 7, wherein if the electronic contract platform signature is selected when the electronic contract platform completes the certificate signature scheme selection step, the electronic contract certificate is signed by using the private key of the electronic contract platform, to obtain the signed certificate; and the electronic contract platform is further configured with:
an uploading determining step: determining whether or not to deposit the electronic contract in the blockchain deposit platform; and when it is determined to deposit the electronic contract in the blockchain deposit platform, proceeding to the transaction construction step to be performed.

10. The smart contract-based electronic contract deposit system according to claim 7, wherein if the deposit platform signature is selected when the electronic contract platform completes the certificate signature scheme selection step, the electronic contract certificate is signed by using a public key of the blockchain deposit platform, to obtain the signed certificate; and the electronic contract platform is further configured with:
an uploading determining step: determining whether or not to deposit the electronic contract in the blockchain deposit platform; and when it is determined to deposit the electronic contract in the blockchain deposit platform, proceeding to the transaction construction step to be performed.
